(19) United States
(12) Patent Application Publication
(10) Pub. No.: US 2025/0355436 A1
(43) Pub. Date: Nov. 20, 2025

(54) METHOD FOR REMOTELY DEACTIVATING AN AUTOMATIC PARKING MODE OF A VEHICLE IN A MULTI-STOREY PARKING LOT AND ASSOCIATED DEACTIVATION DEVICE

(71) Applicant: Continental Automotive Technologies GmbH, Hannover (DE)

(72) Inventors: Fabien DELEPLANQUE, Toulouse (FR); Xavier BRESSAN, Toulouse (FR)

(73) Assignee: Continental Automotive Technologies GmbH, Hannover (DE)

(21) Appl. No.: 19/192,009

(22) Filed: Apr. 28, 2025

(30) Foreign Application Priority Data
May 15, 2024 (FR) FR2404972

(51) Int. Cl. G05D 1/227; B60W 30/06; G05D 107/80; G05D 109/10; G05D 111/50

(52) U.S. Cl. CPC G05D 1/227; B60W 30/06; G05D 2107/80; G05D 2109/10; G05D 2111/52

(57) ABSTRACT

A method for deactivating a remote automatic parking mode of a vehicle in a parking garage. The vehicle being equipped with a tire monitoring system, including wheel units mounted in each wheel of the vehicle and each being provided with an accelerometer measuring a radial component of an acceleration of the wheel and being dependent on a terrestrial gravitational field. The vehicle being provided with an automatic parking mode remotely controlled by portable equipment carried by a user. The method includes, if the conditions for activating the measurements of the wheel units are verified: each wheel unit measuring acceleration values over time; comparing said values with a threshold value, for each wheel unit; if the acceleration values of at least two wheel units exceed said threshold value, then: detecting any movement of said vehicle in a parking garage; and deactivating the remote automatic parking mode.

### CROSS REFERENCE TO RELATED APPLICATIONS

This application claims priority to French Application No. FR2404972, filed May 15, 2024, the contents of such application being incorporated by reference herein.

### FIELD OF THE INVENTION

The invention relates to a method for deactivating a remote automatic parking mode of a vehicle in a parking garage and an associated deactivation device. Therefore, the invention applies to vehicles provided with a remote automatic parking mode whereby parking is automated by the vehicle by virtue of sensors and actuators and is remotely controlled by portable equipment carried by a user. By virtue of this remote automatic parking mode, the user provided with the portable equipment can exit their vehicle and allow the vehicle to park itself completely autonomously. However, they can use their portable equipment to remotely control the activation and deactivation of this automatic parking mode.

### BACKGROUND OF THE INVENTION

Nowadays, more and more vehicles are equipped with a remote automatic parking mode whereby the user no longer needs to be inside their vehicle and to maneuver it in order to park it. In this remote automatic parking mode, the user is located outside the vehicle, within a safety perimeter (approximately within a maximum radius of 6 meters around the vehicle) and is provided with a remote control for controlling the parking of the vehicle. More specifically, the remote control can be a cell phone, for example, or a hands-free device for accessing the vehicle, such as a fob. The user uses this remote control to activate automatic parking of the vehicle whereby the vehicle parks itself completely autonomously by virtue of the information it receives from on-board sensors, such as the reversing camera, radar and the like, and by appropriately activating the necessary actuators, namely the steering wheel, the accelerator pedal and/or the brake pedal, etc.

However, a problem arises when the user wishes to park their vehicle in a fully automated parking garage. In this type of parking lot, which is frequently found in Japan, for example, control of the vehicle is wholly assumed by automatons that park it in the parking lot. An automaton lifts the vehicle in order to take it to a level of the parking lot and then parks it in a space. Therefore, the remote automatic parking mode is no longer necessary, and it would even be dangerous to activate it, as the vehicle could escape the control of the automaton and cause significant damage.

This specific parking mode therefore needs to deactivate the remote automatic parking mode.

At present, the method for deactivating the remote automatic parking mode relies on pressing a button on the fob or an instruction issued by the user on their cell phone. The reliability of the method of the prior art therefore solely depends on the intention and the common sense of the user. It will be readily understood that this method of the prior art is not very robust. Therefore, an aspect of the present invention proposes a robust and reliable method for deactivating the remote automatic parking mode.

### SUMMARY OF THE INVENTION

An aspect of the invention proposes a method for deactivating a remote automatic parking mode of a vehicle in a parking garage, said vehicle being equipped with a tire monitoring system, comprising wheel units mounted in each wheel of said vehicle, the wheel units each being provided with an accelerometer measuring a radial component of an acceleration of said wheel and being dependent on a terrestrial gravitational field, the vehicle also being provided with an automatic parking mode whereby parking is automated by the vehicle by virtue of sensors and actuators and is remotely controlled by portable equipment carried by a user, the method being noteworthy in that it comprises the following steps of:
a. detecting the stationary vehicle;
b. verifying the conditions for activating the measurements of the wheel units;
c. if the conditions are verified, then:
   i. each wheel unit measuring acceleration values over time;
   ii. comparing said values with a threshold value, for each wheel unit;
   iii. if the acceleration values of at least two wheel units exceed said threshold value, then:
      1. detecting any movement of said vehicle in a parking garage; and
      2. deactivating the remote automatic parking mode.

Preferably, the threshold value is equal to 1*g as an absolute value.

An aspect of the invention also relates to a device for deactivating a remote automatic parking mode of a vehicle in a parking garage, said device being adapted to be placed on board said motor vehicle, and comprising a tire monitoring system comprising wheel units mounted in each wheel of said vehicle, the wheel units each being provided with an accelerometer measuring a radial component of an acceleration of said wheel and being dependent on a terrestrial gravitational field, said device according to an aspect of the invention further comprising:
a. means for detecting the stationary vehicle;
b. means for verifying the conditions for activating the measurements of the wheel units;
c. means allowing each wheel unit to measure acceleration values over time, as a function of said verification;
d. means for comparing said values with a threshold value, for each wheel unit;
e. means for detecting any movement of said vehicle in the parking garage as a function of a result of said comparison for at least two wheel units;
f. means for deactivating the remote automatic parking mode as a function of the detection of any movement of said vehicle in the parking garage.

Preferably, the threshold value is equal to 1*g as an absolute value.

An aspect of the invention also relates to a computer program product comprising program code instructions for executing the steps of the method according to any one of the features listed above, when said program is executed on a computer.

Finally, an aspect of the invention applies to any motor vehicle provided with a remote automatic parking mode whereby parking is automated by the vehicle by virtue of sensors and actuators and is remotely controlled by portable equipment carried by a user, the vehicle being noteworthy in that it comprises a deactivation device according to any one of the features listed above.

### BRIEF DESCRIPTION OF THE DRAWINGS

Further features and advantages of aspects of the invention will become more clearly apparent upon reading the following description. This description is purely illustrative and must be read with reference to the appended drawings, in which:

FIG. 1 is a schematic representation of a vehicle equipped with four wheel units measuring pressure, temperature and acceleration in each tire;

FIG. 2 is a schematic representation of a vehicle rim equipped with a wheel unit;

FIG. 3 is a schematic representation of a rim equipped with a wheel unit illustrating the various forces exerted on the wheel unit depending on gravity;

FIG. 4 is a flowchart illustrating the various steps of the method for deactivating the remote automatic parking mode.

### DETAILED DESCRIPTION OF EXEMPLARY EMBODIMENTS

As explained above, the remote automatic parking mode operates by virtue of the sensors and actuators on board the motor vehicle, which allow it to park itself almost completely autonomously and by means of a remote control in the form of a hands-free access fob or a smart phone SD, allowing the user U to activate or deactivate this remote automatic parking mode.

The cell phone SD or fob SD then issues an instruction to activate or deactivate this mode via a wireless communication, of the BLE, “Bluetooth”, or UWB, “ultra-wideband”, type or even over a simple radio frequency to a central electronic control unit 10 on board the vehicle.

With said central electronic control unit 10 being electronically connected to all the sensors and actuators on board the vehicle, and containing the automatic parking software controlling said actuators and sensors, it then proceeds to activate or deactivate the automatic parking mode upon receiving the activation or deactivation instruction sent by the cell phone. This is known in the prior art.

Nowadays, in a motor vehicle V, it is known practice for an electronic measurement module 20 comprising one or more sensors to be mounted in each wheel R, notably in order to detect an anomaly in the wheel with a tire fitted. These sensors 20 can be, for example, a tire inflation pressure sensor connected to the wheel and/or a wheel acceleration sensor.

These sensors, and notably inflation pressure sensors, are mounted in electronic modules/units, called “wheel units” 20, of a tire pressure monitoring system (TPMS).

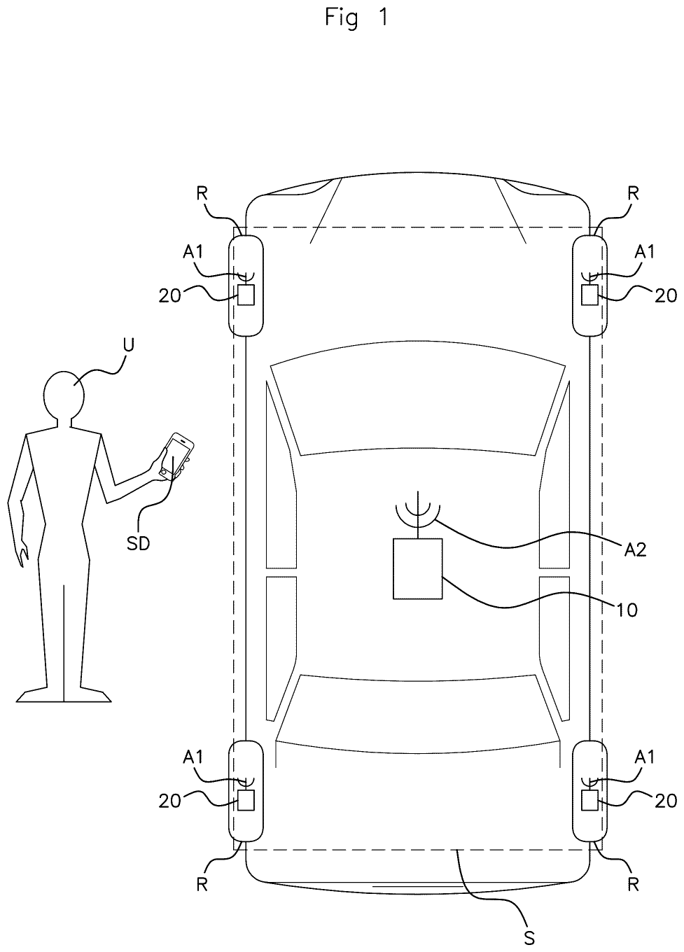

FIG. 1 shows a tire monitoring system S in a motor vehicle V provided with wheel units 20 and with a central electronic unit 10 for controlling the wheel units 20 placed at a distance from the wheel units 20, and, additionally, a cell phone (not shown in FIG. 1) in the possession of an authorized user acting as a device for monitoring and/or controlling the wheel units 20.

As is known, the wheel units 20 generally comprise a microprocessor, a memory, a transceiver, a power supply battery, a pressure sensor and, if applicable, at least one other sensor, such as a radial acceleration sensor capable of measuring the radial accelerations of the wheel or a temperature sensor, mounted on a support forming a printed circuit board or “PCB”.

According to the prior art, each wheel unit 20 connected to a wheel R of the motor vehicle V sends its measurements to a central electronic unit 10 for controlling the wheel units 20 that is integrated in the motor vehicle V and/or a cell phone or equivalent technology provided with an application for communicating with the wheel units 20, with the central electronic unit 10 and the cell phone then being consolidated by being referred to as a device for remotely monitoring and/or controlling the wheel units 20.

To this end, each wheel unit 20 transmits signals to one or more devices 10 for remotely monitoring and/or controlling the wheel units 20 comprising coded messages containing the measurements or other information processed and/or supplied by the wheel units 20.

The other information can include information relating to the geometry of the wheel, notably of the rim and/or of the tire or to the history of the wheel, notably its mileage, specific application data, notably an identification of the wheel units 20, a location of the wheel on the vehicle V and other configurations of the system.

Finally, the processed and/or supplied information can relate to configuration parameters of the software application, or even the executable code in the case of remote reprogramming of the wheel units 20.

The communication between the control device 10 and the wheel unit 20, whether it is a cell phone or a technical equivalent in the possession of an authorized user or the central electronic unit 10 for controlling the wheel units 20 that is integrated in the motor vehicle V, is carried out according to a communication protocol allowing a two-way short-range exchange of data using ultra-high-frequency, or UHF, radio waves according to a communication protocol of the Bluetooth® type or an equivalent protocol between the antennas A1 of the wheel units and the antenna A2 of the central electronic control unit 10. This is known to a person skilled in the art.

Based on the values received from the wheel units 20, the central electronic control unit 10 can formulate, after filtering and sampling, pressure, temperature, wear and/or overload signals for transmission to the on-board computer of the vehicle or to the cell phone in order to notify the user of any anomalies.

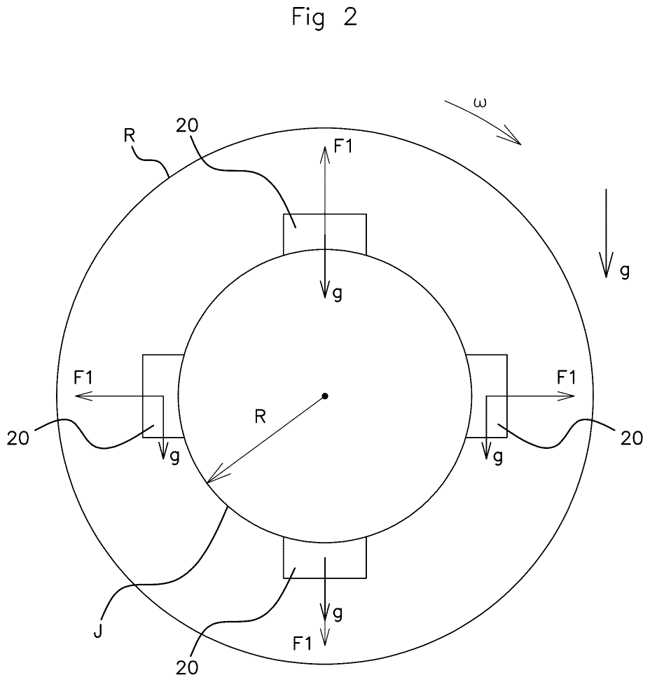

In FIG. 2, the wheel unit 20 located on the rim J of the wheel R includes an accelerometer (not shown) that measures the radial acceleration F1 it experiences at various positions over one wheel revolution, when the wheel rotates in the direction of rotation W. These measurements are preferably carried out at a fixed frequency.

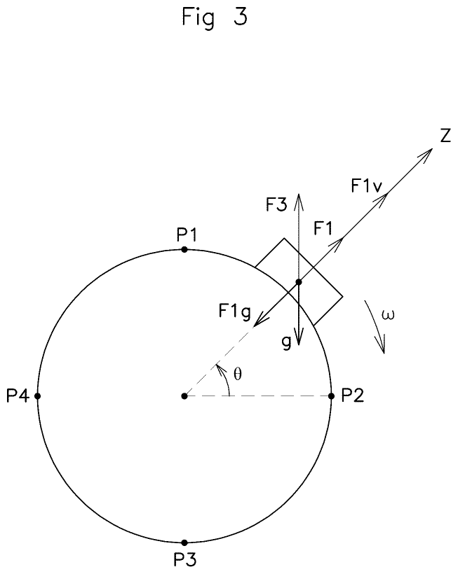

As illustrated in FIG. 3, the acceleration force \vec{F}₁ measured by the radial accelerometer of the wheel unit 20 is the resultant of two radial components, a force \vec{F}_{1g} that is the projection of gravity g in the measurement direction Z of the radial accelerometer and a force \vec{F}₁ᵥ that is the projection of the centrifugal force \vec{F}ᵥ in this same measurement direction Z of the radial accelerometer A, thus:

$${\vec{F}}_{1} = {\vec{F}}_{1 g} + {\vec{F}}_{1 v} \qquad [ Math 1 ]$$

It should be noted that the projection of the centrifugal force in the measurement direction Z of the radial accelerometer is equal to the centrifugal force itself, since this measurement direction Z is directed radially relative to the wheel, and the centrifugal force is exerted radially on the wheel. Consequently:

$${\vec{F}}_{1 v} = {\vec{F}}_{v} \qquad [ Math 2 ]$$

The value of the projection of gravity in the measurement direction of the radial accelerometer at the time t is expressed as follows:

$${F}_{1 g} ( t ) = g \cdot sin ( w ( t ) \cdot t ) \qquad [ Math 3 ]$$

where:
g represents the gravitational constant; it is a vertical vector, oriented downward, with a value of −9.81 m/s2;
w (t) is the angular rotation speed of the radial accelerometer at the time t;
t is the unit of time in seconds.

The value of the centrifugal force is expressed as follows:

$${F}_{v} ( t ) = R \cdot {w ( t )}^{2} \qquad [ Math 4 ]$$

with R being the distance between the accelerometer and the axis of rotation of the wheel, i.e., the radius of the rim.

Consequently:

$${F}_{1} ( t ) = g \cdot sin ( w ( t ) \cdot t ) + R \cdot {w ( t )}^{2} \qquad [ Math 5 ]$$

$$and$$

$$w ( t ) = \frac{v ( t )}{{R}_{P}} \qquad [ Math 6 ]$$

with v(t) being the linear speed of the vehicle, Rp being the radius of the wheel, including the tire.

The curve of the radial acceleration F₁(t) as a function of time is therefore a sinusoid, the maximum MAX and minimum MIN of which respectively correspond to the position of the accelerometer at the bottom of the rim in position P3 and at the top of the rim in position P1. Of course, the minimum and maximum values of the radial acceleration in positions P1 and P3 are not fixed and depend on the speed of rotation of the wheel; therefore, this minimum and maximum can only be determined locally for each wheel revolution and not in absolute terms in relation to fixed value thresholds.

Digital processing of these radial acceleration measurements by the wheel unit, not described herein, and known to a person skilled in the art, is used to determine the minimum value MIN of the radial acceleration and therefore when the accelerometer passes position P1 and/or the maximum value MAX of the radial acceleration and therefore when the accelerometer passes position P3.

Based on this radial acceleration measurement data F1, it is therefore possible, by means of suitable digital processing, to ascertain the passage of the wheel unit at positions P1 and/or P3 on the wheel. The wheel unit 20 can then send a signal to the central unit on completion of this digital processing at these fixed determined positions (or slightly later, taking into account the duration of the digital processing, as explained hereafter). The operation of the wheel units and of the tire under-inflation detection method is known in the prior art.

The method for deactivating the remote automatic parking mode ingeniously proposes using the radial acceleration measurement values originating from the wheel units 20 to detect the presence of the vehicle in a parking garage.

To this end, the deactivation device comprises, in addition to the tire monitoring system S described above:
a. means M1 for detecting the stationary vehicle;
b. means M2 for verifying the conditions for activating the measurements of the wheel units;
c. means M3 allowing each wheel unit to measure acceleration values over time, as a function of said verification;
d. means M4 for comparing said values with a threshold value, for each wheel unit;
e. means M5 for detecting any movement of said vehicle in the parking garage as a function of a result of said comparison with the threshold value for at least two wheel units;
f. means M6 for deactivating the remote automatic parking mode as a function of the detection of any movement of said vehicle in the parking garage.

The means M1 for detecting the stationary vehicle, the verification means M2, the measurement means M3, the comparison means M4, the movement detection means M5 and the deactivation means M6 are preferably in the form of software included in an integrated circuit located in the central electronic control unit 10.

The means M1 for detecting the stationary vehicle are, for example, able to detect that the vehicle speed is zero.

The means for verifying the conditions for activating the measurements of the wheel units verify that the following conditions are effectively met:
a. the vehicle engine is stopped, i.e., the ignition is off;
b. the vehicle speed is zero in the direction of travel parallel to roads, in other words the vehicle is not actively driving the wheels.

The means M3 allowing each wheel unit to measure the acceleration values over time include an accelerometer located in each wheel, together with data processing software.

The measurement means M3 using the accelerometer integrated in each wheel unit provide a value representing the force of gravity projected along the measurement axis of the radial accelerometer over time (t), according to the formula expressed above, see [Math 3].

$${F}_{1} ( t ) = g \cdot sin ( w ( t ) \cdot t ) + R \cdot {w ( t )}^{2} \qquad [ Math 3 ]$$

According to an aspect of the invention, when the vehicle is stationary with the engine switched off, the radial acceleration of the wheels is zero, consequently:

$$R \cdot {w ( t )}^{2} = 0 \qquad [ Math 7 ]$$

$$and :$$

$${F}_{1} ( t ) = g \cdot sin ( w ( t ) \cdot t ) \qquad [ Math 8 ]$$

If the vehicle is lifted by a parking lot automaton, the vehicle experiences an additional lifting force F₃(t) directed either opposite the force of gravity or in the direction of gravity, which is expressed by the following formula:

$${F}_{3} ( t ) = K ( t ) \cdot g \qquad [ Math 9 ]$$

Where K (t) is a constant strictly greater than 0.

### Therefore:

$${F}_{1} ( t ) = g \cdot sin ( w ( t ) \cdot t ) + K ( t ) \cdot g \qquad [ Math 10 ]$$

In other words, when the vehicle has its engine switched off, is not traveling along a road but is lifted vertically by an automaton, the force F1 experienced by the accelerometer is a function of gravity, i.e.:

$${F}_{1} ( t ) = {K}^{′} ( t ) \cdot g \qquad [ Math 11 ]$$

The comparison means M4 then compare said value F₁(t) as an absolute value with a threshold value S1. For example, the threshold value S1 is equal to 1*g.

The detection means M5 are able to detect a movement of the vehicle in the parking garage according to the result of said comparison.

In other words, if the value of the force F₁(t) experienced by the accelerometer is greater than the threshold S1, then the vehicle is moving in a parking garage.

The deactivation means M6 are able to deactivate the remote automatic parking mode according to any detection of movement of the vehicle in the parking garage. If the vehicle is detected as moving in the parking garage, then the deactivation means deactivate the remote automatic parking mode.

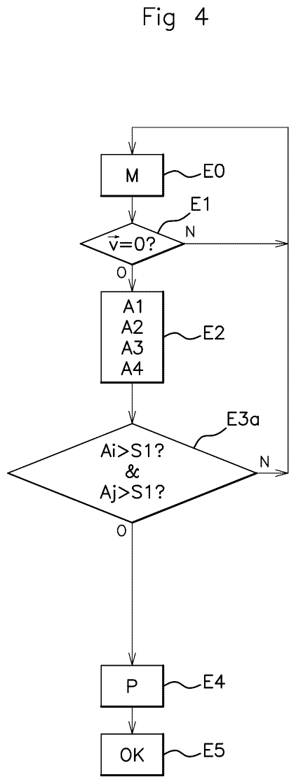

The deactivation method, which is illustrated in FIG. 4, will now be described.

During a preliminary step E0, the vehicle is detected as being stationary. The vehicle is therefore static.

A first step E1 involves verifying that the conditions for activating the measurements by the accelerometers are verified, namely the vehicle engine is switched off, and the vehicle is not traveling in a direction parallel to a road, i.e., its speed v is zero.

If the conditions are not met, the method returns to the preliminary step E0.

In a second step, E2 each wheel unit 20 present on the vehicle takes acceleration measurements F1(t) for each of the four wheel units 20 on board the vehicle V, over time t using its integrated accelerometer.

As explained above, this acceleration measurement F1(t) is a function of gravity g.

In the third step, the acceleration measurements F1(t) thus provided by the wheel units 20 are each compared (see step E3a) with a threshold value S1, equal to 1*g, with g being the gravitational constant, equal to 9.81 m/s².

As previously shown, when the engine is switched off, the vehicle V is stationary but is being moved vertically by a lifting force exerted by an automaton in the parking lot, the force F1(t) experienced by the accelerometer is a function of the gravitational force; it is exerted in the direction of gravity if the automaton lowers the vehicle or is exerted in the opposite direction to gravity if the automaton lifts the vehicle V.

It should be noted that the threshold value S1 is to be used as an absolute value since the automaton can either lower or raise the vehicle V.

If values originating from at least two wheel units 20 are greater than the threshold value S1, then, according to an aspect of the invention, the vehicle is considered to be in vertical motion in a parking garage (see step E4).

If the vehicle is detected as moving in a parking garage, then the remote automatic parking mode is deactivated (step E5).

Therefore, an aspect of the invention is ingenious in that it uses the tire monitoring system on board the vehicle to perform the additional function of detecting movement in a parking garage.

An aspect of the invention is inexpensive, as it only includes software means in addition to the existing monitoring system on the vehicle.

1. A method for deactivating a remote automatic parking mode of a vehicle in a parking garage, said vehicle being equipped with a tire monitoring system, comprising wheel units mounted in each wheel of said vehicle, the wheel units each being provided with an accelerometer measuring a radial component of an acceleration of said wheel and being dependent on a terrestrial gravitational field, the vehicle also being provided with an automatic parking mode whereby parking is automated by the vehicle by virtue of sensors and actuators and is remotely controlled by portable equipment carried by a user, the method comprising:
a) detecting the stationary vehicle;
b) verifying the conditions for activating the measurements of the wheel units comprising:
i) verifying that a vehicle engine is switched off;
ii) verifying that the vehicle speed is zero in a direction of travel parallel to roads;
c) if the conditions are verified, then:
i) each wheel unit measuring acceleration values over time;
ii) comparing said values with a threshold value, for each wheel unit;
iii) if the acceleration values of at least two wheel units exceed said threshold value, then:
1) detecting any movement of said vehicle in a parking garage; and
2) deactivating the remote automatic parking mode.

2. The deactivation method as claimed in claim 1, wherein the threshold value is equal to the gravitational constant.

3. A device for deactivating a remote automatic parking mode of a vehicle in a parking garage, said device being adapted to be placed on board said motor vehicle, and comprising a tire monitoring system comprising wheel units mounted in each wheel of said vehicle, the wheel units each being provided with an accelerometer measuring a radial component of an acceleration of said wheel and being dependent on a terrestrial gravitational field, said device comprising:
a) means for detecting the stationary vehicle;
b) means for verifying the conditions for activating the measurements of the wheel units, comprising means for verifying that a vehicle engine is switched off and that the vehicle speed is zero in a direction of travel parallel to roads;
c) means allowing each wheel unit to measure acceleration values over time, as a function of said verification;
d) means for comparing said values with a threshold value, for each wheel unit;
e) means for detecting any movement of said vehicle in the parking garage as a function of a result of said comparison for at least two wheel units;
f) means for deactivating the remote automatic parking mode as a function of the detection of any movement of said vehicle in the parking garage.

4. The deactivation device as claimed in claim 3, wherein the threshold value is equal to the gravitational constant.

5. A computer program product comprising program code instructions for executing the method as claimed in claim 1, when said program is executed on a computer.

6. A motor vehicle provided with a remote automatic parking mode whereby parking is automated by the vehicle by virtue of sensors and actuators and is remotely controlled by portable equipment carried by a user, the vehicle comprising a deactivation device as claimed in claim 3.
